(19) United States
(12) Patent Application Publication
(10) Pub. No.: US 2025/0062509 A1
(43) Pub. Date: Feb. 20, 2025

(54) TERMINAL RIVET FOR A SECONDARY CELL

(71) Applicant: NORTHVOLT AB, Stockholm (SE)

(72) Inventor: Dongho SON, Stockholm (SE)

(21) Appl. No.: 18/790,298

(22) Filed: Jul. 31, 2024

(30) Foreign Application Priority Data
Aug. 16, 2023 (SE) 2350971-4

(51) Int. Cl. H01M 50/567; H01M 50/152; H01M 50/559

(52) U.S. Cl. CPC H01M 50/567; H01M 50/152; H01M 50/559

(57) ABSTRACT

There is disclosed herein a terminal assembly for a cylindrical secondary cell. In the terminal assembly, there is a rivet provided with an external portion configured to close an opening in a casing of the cylindrical cell and to be arranged substantially on the outside of the casing, and an internal portion configured to provide a direct electrical connection between an electrode roll in the secondary cell and the external portion. On the he internal portion there is a shaft configured to extend axially through the casing of the secondary cell from the external portion, and a current collecting portion joined to the shaft, configured to be in direct electrical contact with the electrode roll in the secondary cell, to thereby function as a current collecting plate in the secondary cell. Also disclosed is a cylindrical secondary cell and a method for manufacturing a cylindrica secondary cell.

### BACKGROUND

### Related Field

The present disclosure relates to a terminal rivet for a secondary cell, a secondary cell comprising the terminal rivet, and a method of manufacturing such a secondary cell.

### Related Art

In addressing climate change, there is an increasing demand for rechargeable batteries, e.g. to enable electrification of transportation and to supplement renewable energy. Currently, lithium-ion batteries are becoming increasingly popular. They represent a type of rechargeable battery in which lithium ions move from the negative electrode to the positive electrode during discharge and back when charging.

As the demand for rechargeable batteries increases, more and more focus is being placed on production speed and cost. To achieve an effective production of rechargeable batteries, the design of the batteries as well as their manufacturing process can be optimized.

### BRIEF SUMMARY

The present disclosure aims to provide improved secondary cells and parts thereof. The improvements may be in energy performance, manufacturing efficiency, decreased amount of material used, and assembly simplification, among others.

In particular, according to an aspect of the present disclosure, there is provided a terminal assembly for a cylindrical secondary cell comprising a rivet. The rivet comprises an external portion configured to close an opening in a casing of the cylindrical cell and to be arranged substantially on the outside of the casing, and an internal portion configured to provide a direct electrical connection between an electrode roll in the secondary cell and the external portion. The internal portion comprises a shaft configured to extend axially through the casing of the secondary cell from the external portion, and a current collecting portion joined to the shaft configured to be in direct electrical contact with the electrode roll in the secondary cell, to thereby function as a current collecting plate in the secondary cell.

Herein, the term “terminal rivet assembly” is intended to define the fact that this assembly, according to the present disclosure, is an integrally formed terminal rivet and current collecting plate. It is not one or the other, but the terminal assembly disclosed herein can be utilized to at the same time close an opening in the cylindrical casing of a cylindrical secondary cell and to provide a direct electrical connection to the electrode roll. It also refers to the fact that the terminal rivet assembly could comprise parts in addition to the terminal rivet, such as the cover part discussed below.

The overall shape of the cylindrical secondary cell may be substantially determined by its cylindrical casing, extending between two substantially flat ends. The first end of the cylindrical casing comprises an opening for receiving a rivet. The opening may be shaped and sized to correspond to a shape and size of the shaft of the rivet, allowing as well for the addition of a gasket around said shaft. The external portion of the rivet may then extend like a flange from the second end of the shaft, such that the external portion is larger than the opening in the casing.

In conventional cylindrical secondary cells, the head of a terminal rivet acts as an external terminal for the cell by being electrically conductive (e.g., formed from a metal such as aluminum or an alloy thereof) and electrically connected, via the first end of the shaft, to a current collecting disc. The current collecting disc (e.g., a cathode disc formed of aluminum or an alloy thereof) may then be arranged in direct electrical contact with the exposed tabs of the electrode roll of the cell (e.g., cathode tabs), at a first end of the electrode roll.

When shaft of the rivet is introduced into the opening of the casing, having a gasket therearound and a part of the gasket extending between the head and the casing of the cell, the opening in the casing may be sealed in a substantially fluid-tight manner. The first end of the shaft is then riveted and thereby deformed to retain the rivet in place in the opening of the casing, in a manner understood by those skilled in the art.

According to the present disclosure, the terminal rivet comprises a current collecting portion configured to be in direct electrical contact with the exposed tabs of the electrode roll of the cell (e.g., cathode tabs), at a first end of the electrode roll. Thus, issues related to the step of arranging a rivet in a cylindrical secondary cell in contact with the current collecting disc can be mitigated. In particular, since the current collecting portion is formed integrally with the rivet in the present disclosure, the terminal assembly disclosed herein mitigates issues relating to the alignment of a rivet in relation to the current collecting plate, as well as issues relating to the welding of the rivet to the current collecting plate.

The current collecting portion preferably comprises a first side to which the shaft is joined, and a second side configured to contact the electrode roll. Similarly, the external portion of the rivet preferably comprises a first side to which the cover is configured to be attached, and a second side to which the shaft is joined. Thus, an integrally terminal rivet assembly comprising both terminal rivet and current collecting portion can be provided. The terminal assembly may preferably be manufactured by machining, by means known to the skilled person in the art.

When manufacturing a cylindrical secondary cell according to aspects of the present invention, the terminal rivet of the terminal assembly is arranged such that the current collecting portion is in direct electrical contact with exposed tabs of the electrode roll. The current collecting portion is then welded to the exposed tabs at the first end of the electrode roll. After welding, the electrode roll is joined to the terminal rivet via the weld between the current collecting portion and the exposed tabs at the first end of the electrode roll.

The welding of the current collecting plate and the electrode roll forms a reliable electrical and mechanical connection therebetween. Such welding (or soldering) may be performed by any suitable means such as a welding laser, ultrasonic welding, capacitor discharge welding, or the like. Advantageously, the welding means is performed before the electrode roll and rivet are inserted into the casing of the cell. Thereby, a manufacture of the secondary cell is greatly simplified and ejecta resulting from such welding are advantageously kept from contaminating an internal of the cell.

The electrode roll and rivet is then positioned in the cylindrical casing such that the shaft of the rivet extends through an opening at the first end of the casing. The opening may be shaped and sized to correspond to a shape and size of the shaft of the rivet, allowing as well for the addition of a gasket around said shaft.

Hence, when the shaft of the rivet is introduced into the opening of the casing, having a gasket therearound and a part of the gasket extending between the head and the casing of the cell, the opening in the casing may be sealed in a substantially fluid-tight manner.

Due to the fact that the rivet comprises the current collecting portion, it is not possible to rivet and thereby deform the part of rivet (i.e. the shaft) extending inside the casing. Instead, the external portion of the rivet is then riveted and thereby deformed to retain the rivet in place in the opening of the casing, in a manner understood by those skilled in the art. The external portion of the rivet then extends like a flange from the second end of the shaft, such that the external portion is larger than the opening in the casing.

The part of the gasket around the shaft thus forms a fluid seal for the opening in the casing to retain liquid electrolyte within the cell. At least this part of the gasket may thus be preferably configured for mechanical resilience and resistance against corrosion.

The part of the gasket between the head of the rivet and the end of the casing around the opening electrically insulates the head of the rivet from the casing. At least this part of the gasket may thus be preferably configured for electrical insulation. Both parts of the gasket (which may be monolithically formed) may be preferably configured to withstand the highest temperatures expected to be incident thereupon during manufacture and operation of the cell.

Since the external portion is electrically conductive (e.g., formed from a metal such as aluminum or an alloy thereof) contact with the electrode roll via the internal portion, it can now as an external terminal for the cell.

At the other end of the electrode roll, further exposed tabs may extend therefrom (e.g., anode tabs) and may be electrically connected (directly or via a further current collecting disc) to the casing of the cell, which may be formed of metal such as nickel-plated steel or aluminum. Accordingly, the entire surface of the casing, including the end of the casing having the opening closed by the terminal rivet, may act as one electrode of the battery, and the external portion of the terminal rivet may act as another (opposite) electrode of the battery. Hence, both terminals of the cell may advantageously be available for connecting to (e.g., via busbars in a battery module) at the same end of the cylindrical secondary cell. The external portion of the terminal rivet may act as a positive (cathode) terminal for the cell and the exposed surface of the casing surrounding the terminal rivet may act as a negative (anode) terminal for the cell.

That is, in an example implementation of a cylindrical secondary cell, the first end of the casing comprises a first electrical contact surface extending in a first plane, and the external portion of the terminal rivet comprises a second electrical contact surface, extending in a second plane axially spaced from the first plane, i.e., away from the casing.

When installing such cells into a battery module, busbars or other connectors may be welded or otherwise connected along the terminals of the cells to thereby electrically interconnect the cells within the battery module.

The terminal assembly may further comprise a cover part configured to be attached to the rivet to cover, and with an inner surface electrically contact, the external portion of the rivet, such that an outer surface of the cover part is configured to form a terminal surface of the secondary cell.

Due to the fact that the terminal rivet of the present disclosure is riveted in a manner which deforms an external portion of the rivet, as compared conventional rivets in which a shaft portion are deformed, the upper surface of the external portion of the terminal rivet may become uneven during the riveting process. Consequently, it may be difficult to attach the external portion to busbars or other connectors. Therefore, the terminal assembly may further comprise a cover part configured to cover the external portion of the rivet. The cover part is electrically conductive and made of a material which can readily be welded to the external portion. (e.g., formed from a metal such as aluminum or an alloy thereof) Thus, the cover portion can now act as an external terminal for the cell. Consequently, any surface unevenness introduced in the external portion by the riveting process can be covered by a cover part having a flat surface. Thus, an enhanced attachment surface on the terminal rivet is provided for attaching to busbars or other connectors.

In embodiments, the shaft of the rivet may be cylindrical and configured to extend axially through a circular opening in the casing of the cylindrical secondary cell. In this embodiment, the external portion of the rivet is preferably substantially disc shaped, and configured to close the circular opening in the casing of the cylindrical secondary cell by being sized larger than the opening.

In embodiments, the current collecting portion may be substantially disc-shaped. Since the electrode roll typically has a cylindrical shape, a disc-shape substantially corresponds to the shape of the exposed top comprising the electrode tabs of the electrode roll. Preferably, the current collecting portion has a diameter which corresponds to the diameter of the electrode roll, which in turn preferable has a diameter which allows it to fit snugly inside the casing of the secondary cell.

In some embodiments, a diameter of the current collecting portion is larger than a diameter of the external portion, and/or a diameter of the external portion is larger than a diameter of the shaft. This allows the terminal rivet to form a fluid tight seal when the opening in the casing is substantially fluid tight.

In some embodiments, the cover part comprises a substantially disk-shaped portion, wherein a first surface of the substantially disk shaped portion forms the outer surface of the cover part being configured to form a terminal surface of the secondary cell; and a wall portion extending from the periphery of the substantially disc shaped portion on a second surface of the disc-shaped portion. The disc shaped portion is preferably manufactured such that its diameter corresponds to a diameter of external portion of the rivet. The wall portion preferably has a height which corresponds to a thickness of the external portion. Thus, a cover part which fits snugly and can cover the external portion when the rivet is arranged in an opening in the casing in the cylindrical cell can be provided.

The cover part may for example be manufacture by means of machining a blind hole inside a disc. It may also be formed by welding a hollow cylinder onto a disc, or by other means readily contemplated by the person skilled in the art.

In some embodiments, the cover part is configured to completely cover the head of the rivet, when the rivet is arranged in the secondary cell. By sizing the cover part such that it can completely cover the external portion, an even and correctly dimensioned terminal part can be provided by the cover part. Any unevenness or imperfections caused by the riveting deformation can be hidden under the cover part. By welding the cover part to the external portion, electrical conductivity and mechanical stability is ensured.

In some embodiments, wherein the outer facing surface of the external surface of the rivet is substantially uneven. Such unevenness typically can typically be attributed to the deformation of the external portion during riveting. It can also be attributed to particular designs of the external portion, such as the provision of grooves, recesses or similar. Such groove, recesses or similar may for example have been provided in order to minimize stresses in the rivet. In these embodiments, the provision of a cover part is particularly advantageous.

In some embodiments, the outer surface of the cover part is substantially flat. This is to ensure connection possibilities as the cover part is intended to act as an external terminal in the cell. An inner surface of the cover part may have a shape which substantially corresponds to the shape of the deformed external portion, to ensure a large surface area for welding.

In another aspect of the present disclosure, there is provided a cylindrical secondary cell, comprising an electrode roll housed in a cylindrical casing, and the terminal assembly substantially as described above, arranged at a first end of the cylindrical casing. Additional features of the cylindrical secondary cell are described in relation to the previous aspect discussed in this disclosure.

In some embodiments, the terminal assembly comprising the cover part as described above, wherein an outer surface of the cover part forms a terminal surface of the secondary cell.

In another aspect of the present disclosure, there is provided a method of manufacturing the cylindrical cell as defined above. The method comprises directing welding means to the current collecting portion to thereby weld the current collecting portion to a connecting portion of the electrode roll, to provide an electrical connection between the external portion and the electrode roll, arranging the rivet and the electrode roll in the cylindrical casing such the rivet is arranged at a first end of the cylindrical casing, and riveting the rivet, to deform the head and thereby attach the rivet to the cylindrical casing.

The manufacturing method advantageously allows the current collecting portion of the terminal assembly to be joined to the electrode tabs of the electrode before the electrode roll is inserted into the casing of the secondary cell. Thus, alignment of the electrode tabs in relation to the current collecting portion is not hindered by the walls of the casing. It also allows for welding means to be directed onto the current collecting portion instead of onto the electrode tabs, which are more delicate. Furthermore, any compromises in the joint can be discovered and remedied before the electrode roll is inserted in the casing. Accordingly, the case of manufacture of the cylindrical secondary cell is enhanced as it is not required to direct or maneuver the welding means internally within the casing of the cell. Moreover, the risk of ejecta from the welding process contaminating an internal of the cell is advantageously reduced.

The electrode roll may comprise respective pluralities of notched tabs extending from its ends, wherein a first plurality of notched tabs are extensions of or attachments to the cathode electrode sheet, and a second plurality of notched tabs at the opposite end are extensions of or attachments to the anode electrode sheet. The tabs may be folded over to form a connective surface for welding or otherwise attaching a current collecting plate to.

Hence, in an assembled form of the cylindrical secondary cell, electrical energy stored in the electrode roll may be collected by the current collecting portion and provided, via an electrically conductive connection therebetween, to the external portion of the terminal rivet.

The welding means may be a welding laser, soldering iron, ultrasonic welding, capacitor discharge welding, or any other suitable welding means whose welding energy may be effectively communicated through the material path formed between the relatively thin current collecting plate.

Once the welding is complete, the rivet and the electrode roll is then arranged in the cylindrical casing such the rivet is arranged at a first end of the cylindrical casing. The rivet is arranged such that the external portion is on the outside of the cylindrical casing. The shaft the extends through the opening of the cylindrical casing to the current collecting portion. Since the shaft and the current collecting portion are configured to be arranged in an interior of the casing, they are referred to as being comprised in the internal portion of the terminal rivet.

The terminal rivet may have a gasket arranged therearound, which serves a first purpose to create a fluid-tight seal between the terminal rivet and the opening in the first end of the casing, and a second purpose to form an electrically insulating layer between the terminal rivet and the casing. The gasket may preferably extend substantially radially beyond the external portion of the terminal rivet to reliably insulate the external portion of the terminal rivet, acting as one terminal of the cell, from the casing, acting as the other terminal of the cell.

After the terminal rivet has been arranged in the casing, the external portion of the terminal rivet is riveted to thereby secure the terminal rivet in place at the first end of the casing. Such riveting deforms the external portion which may cause the surface of the external portion to become uneven. The riveting is performed by application of a force to the external portion. The force should be sufficient to plastically deform the external portion of the rivet.

Riveting may be performed be a plethora of means known to the person skilled in the art.

In embodiments, the method further comprises arranging the cover part to cover and with an inner surface electrically contact the head of the rivet, and directing a welding means the outer surface of the cover part, to thereby weld the cover part to the head of the rivet.

As discussed above, the riveting of the external portion of the terminal rivet may cause the external portion to deform in a manner which makes it upper surface uneven. It could be contemplated that such unevenness could be handled by machining during the assembly of the cell. However, to improve the workflow of manufacture, a cover part could instead be provided to cover the external portion and welded to the external portion. Consequently, an electrical connection is formed between the electrode roll and the cover part, which allows the external portion to act as a terminal in the secondary cell.

The welding may preferably be performed by directing the same welding means as utilized to weld the terminal assembly to the electrode roll, or a different one. At least, it may be similar in function to the other welding means discussed herein.

Since the outer shaped of the cover part can be manufactured prior to the manufacture of the cell, the terminal part of the cell may require no further treatment once the cover part has been welded in place. Preferably, the cover part has been designed to meet the requirements set by the connection means present in the application in which the cell is to be utilized.

Accordingly, aspects of the present disclosure provide improvements in energy performance, manufacturing efficiency, and assembly simplification, for terminal rivets and the cylindrical secondary cells in which they are installed, among other advantages which will be made clear through the below description of specific embodiments.

### BRIEF DESCRIPTION OF THE FIGURES

One or more embodiments of the present disclosure will be described, by way of example only, and with reference to the following figures, in which:

FIG. 1A schematically shows a side cross-sectional view of a terminal rivet assembly according to aspects of the present disclosure;

FIGS. 1B and 1C schematically shows a top view of a rivet and a bottom view of a cover part according to aspects of the present disclosure, respectively;

FIG. 2A schematically shows a side cross-sectional view of an terminal rivet assembly having an alternative rivet;

FIGS. 2B and 2C schematically show a top view of the alternative rivet of FIG. 2A and a bottom view of the cover part, respectively;

FIGS. 3A, 3B and 3C schematically show side cross-sectional views of a rivet before riveting, after riveting, and after attachment of the cover part, according to aspects of the present disclosure, respectively;

FIG. 4 schematically shows a cross-sectional view of a cylindrical secondary cell according to aspects of the present disclosure;

FIG. 5 schematically shows a cross-sectional view of a cylindrical secondary cell using an alternative rivet in the terminal rivet assembly;

FIGS. 6A-6E schematically show attachment and welding of the terminal rivet to the electrode roll, according to aspects of the present disclosure;

FIG. 7 illustrates a method of manufacturing a cylindrical secondary cell, according to aspects of the present disclosure.

### DETAILED DESCRIPTION

The present disclosure is described in the following by way of a number of illustrative examples. It will be appreciated that these examples are provided for illustration and explanation only and are not intended to be limiting on the scope of the present disclosure. Instead, the scope of the present disclosure is defined by the appended claims.

Furthermore, although embodiments be presented individually for the sake of focused discussion of particular features, it will be recognized that the present disclosure also encompasses combinations of the embodiments described herein.

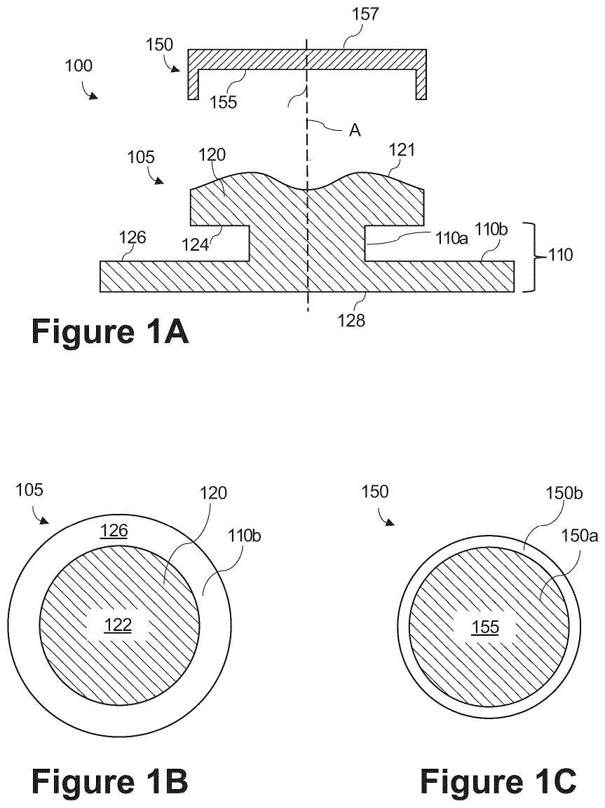

FIGS. 1A-C show a side cross-sectional view of a terminal rivet assembly 100, a top view of the rivet 105 and a bottom view of the cover part 150, respectively, according to aspects of the present disclosure.

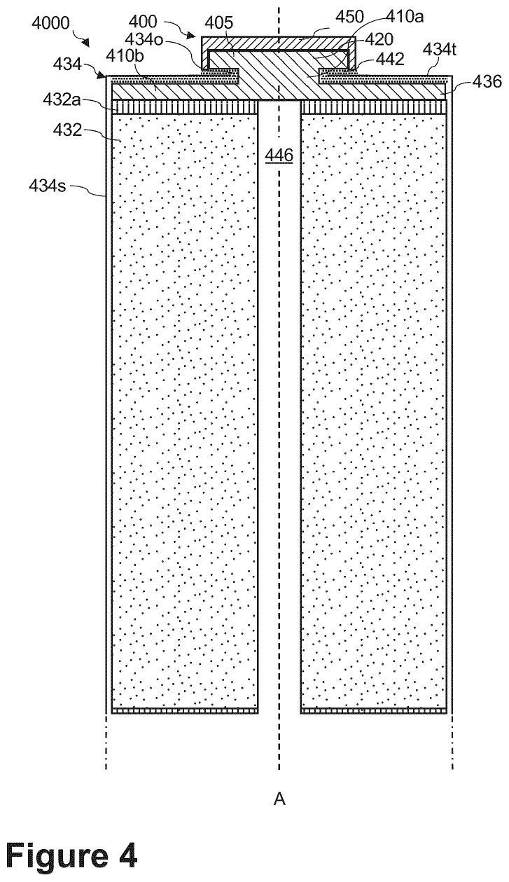

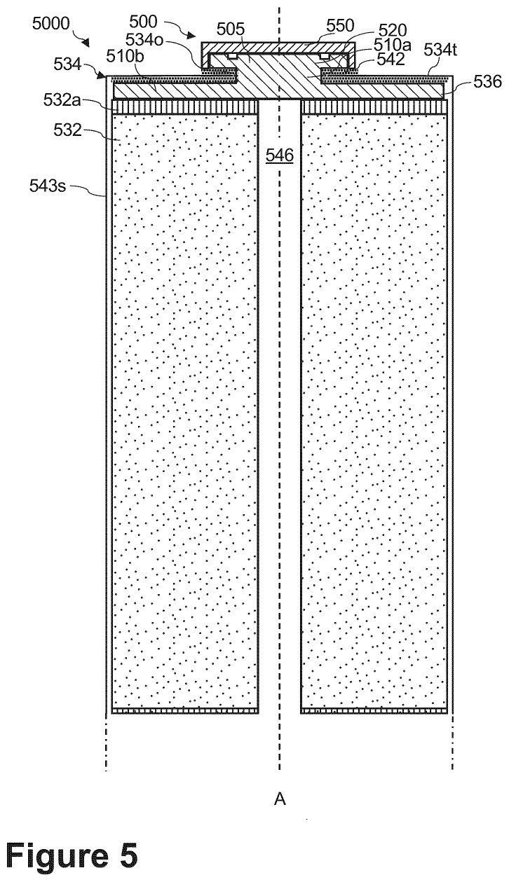

In the illustrated example shown in FIG. 1A, the terminal rivet assembly 100 comprises a cover part 150 and a rivet 105. The terminal rivet 105 comprises an external portion, configured to be arranged on an outside of a casing of a cylindrical secondary cell, and an internal portion, adapted to be positioned in an interior of the cell, on the inside of the casing of the cell. The internal portion 110 comprises a shaft 110 and a current collecting portion 110b. The current collecting portion 110b is configured to directly contact a connecting portion of an electrode roll in a cylindrical secondary cell on the surface 128. The shaft 100a extends along an axis A between the external portion 120 from the surface 124 and the current collecting portion 110b to the surface 126, as shown in further detail in FIGS. 4 and 5. Thus, the current collecting portion 110b is configured to take the place of current collecting plate which is conventionally used in prior art secondary cells to connect a terminal rivet to the electrode tabs of the electrode roll. The terminal rivet shown in FIG. 1A can thus provide a direct electrical connection to the electrode roll in a cylindrical secondary cell, from the current collecting portion 110b via the shaft 110a to the external portion 120. In this illustrated example, the shaft 110a is formed substantially as a cylinder, and the external portion 120 and the current collecting portion 110b are each formed as a disc (i.e., as a cylinder having a greater radius than the first portion of the shaft 110a) and the substantially circular profiles of the shaft 110a, the current collection plate 110b and external portion 120 are concentric around the axis A.

In the illustrated example, the external portion 120 comprises an upper surface 121 which is uneven, i.e. not flat. This uneven surface is attributed to the fact that the external portion 120 has been deformed during riveting of the terminal rivet 105. In conventional rivets for cylindrical secondary cell, it is the parts of the rivet that is extends in the interior of casing that are deformed during the riveting process, while the exterior parts are usually not deformed by the riveting. However, since the illustrated terminal rivet 105 is provided with a current collecting portion 110b, which cannot be deformed without hampering its function for the purpose of contacting the electrode roll, the external portion 120 of the terminal rivet 105 has instead been deformed to secure the terminal rivet assembly 100 in the secondary cylindrical cell. This deformation can introduce unevenness in the surface 121 which potentially reduces the surface area available for further of the cell.

To alleviate this, embodiments of the present disclosure further provides a cover part 150 arranged to be placed over the external portion 120 of the terminal rivet 105 in the terminal rivet assembly 100. The cover part 157 is manufactured to have a flat upper surface 157, which is suitable for attachment to various relevant structures in the applications of the secondary cell.

The cover part 150 is also formed of a substantially disc-shaped portion 150a and a wall portion 150b extending from a periphery of said disc-shaped portion 150a. In this illustrative example, the cover part 150 is sized and shaped such that it substantially covers the external portion 120 of the rivet, when the terminal assembly is arranged in a cylindrical secondary cell. This is further illustrated in FIGS. 1B and 1C, which show a top view of the rivet 105 and a bottom view of the cover part 150, respectively. The disk-shaped external portion 120 of the rivet 105 has a diameter which substantially corresponds to a diameter of the disk-shaped portion 150a of the cover part 150. The wall portion 150b extends from a periphery of the disk-shaped portion 150a, thereby allowing the cover part 150 to substantially cover the external portion 120 of the rivet 105, when the terminal rivet assembly 100 is arranged in a cylindrical secondary cell. In FIG. 1A, it is shown that the height h of the wall portion 150b substantially corresponds to a thickness t of the head portion 120.

The internal portion 110 of the rivet 105 according to the present disclosure comprises a current collecting plate 110b which is adapted to be in direct electrical contact with electrode tabs of an electrode roll in a cylindrical secondary cell. Consequently, the rivet 105 of the rivet assembly 100 of the present disclosure provides an integrally formed rivet 105 and current collecting plate. In prior art cells, a current collecting plate is typically arranged in the secondary cell between the terminal rivet and the electrode roll, such that it is in electrical contact with the terminal rivet and the electrode roll. The rivet is the positioned such that it, after riveting, can be attached to the current collecting plate by means of e.g. welding. In the present disclosure, there is provided a current collecting plate 110b on the shaft 110a the rivet 105, which current collecting plate is configured to be in direct electrical contact with a connecting portion of the electrode roll. This means that the additional manufacturing step of attaching (by e.g. welding) the shaft 110 of the rivet 105 a current collecting plate can be omitted.

As can be seen in FIG. 1B, the second portion 110b (illustrated herein as substantially disc-shaped) has a diameter which is larger than a diameter of the substantially disc-shaped external portion 120. The current collecting plate 110b is preferably sized and shaped such that it can be in electrical contact with and substantially cover a connecting portion of an electrode roll in the secondary cell.

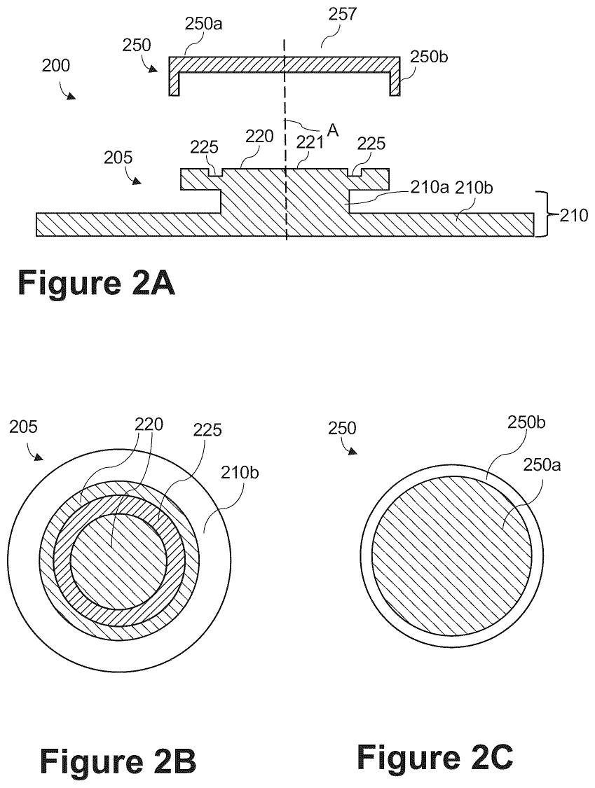

FIG. 2 schematically show an alternative terminal rivet assembly 200 according to the present disclosure. The terminal rivet assembly 200 shown in FIGS. 2A-C differs from the terminal rivet assembly 100 shown in FIG. 1A-C in that the external portion 220 is provided with a groove 225 extending concentrically around the axis A. In the prior art, such similar grooves could cause problems when the external portion of a rivet is intended to act as a terminal assembly in the cell. According to the present disclosure, the cover part 250 is intended to cover the external portion 220 of the terminal rivet 205. Since the upper surface of the cover part 250 is substantially flat, it can be utilized as a terminal in the secondary cells without requiring any further treatment.

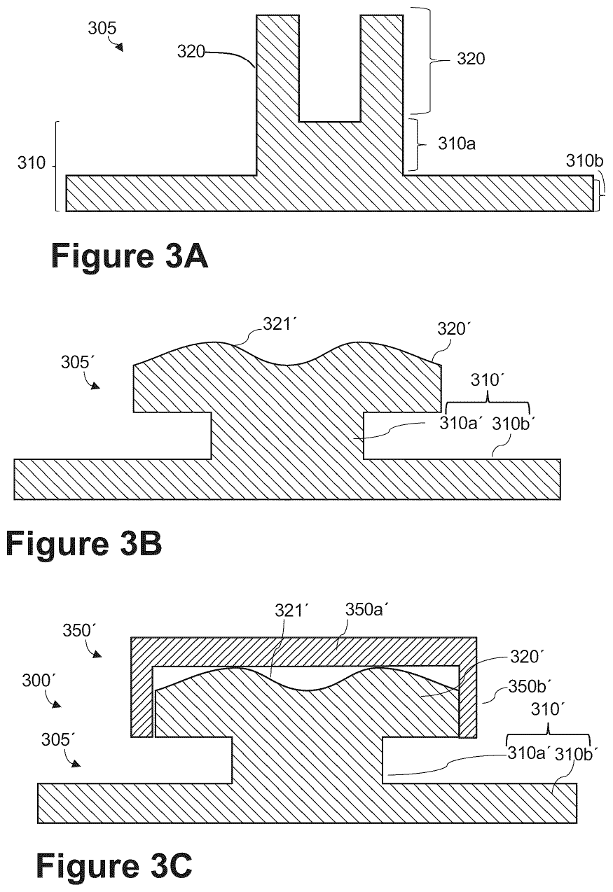

FIG. 3A-3C schematically show a rivet 305 before riveting, a rivet 305′ after riveting, and a terminal rivet assembly 300 comprising the rivet 305′ and a cover part 350 attached to the head 320 of the rivet 305′.

The rivet 305 may formed by, for example, cold pressing, additive or subtractive manufacturing, or other techniques, depending on the material from which the rivet 305a is formed (such as aluminum or an alloy thereof). In its pre-riveted state, the interion portion 310 of the rivet 305 comprises a current collecting plate 310b intended to contact electrode tabs in a cylindrical secondary cell. In the illustrated example, the internal portion 310b is not intended to deform during a riveting process, as this would be likely to damage the current collecting plate 310b for the purpose of acting as a current collecting plate in the secondary cell.

Consequently, the rivet 305′ formed in the riveting process is a combined, integral rivet 305′ and current collecting plate.

Different from conventional terminal rivets, it is instead the external portion 320 that is intended to be deformed during the riveting portion, so that the rivet can be firmly attached to the casing of the cell. During said riveting process, the external portion 320 is deformed such that the external portion 320′ is formed. Due to the high pressures applied in the riveting process, it is common that the head 320′ becomes deformed such that a surface 321′ of the external portion 320′ is no longer flat. Such uneven surface may cause problems if intended to be used as a terminal portion of the secondary cell. To alleviate this issue, the present disclosure provides a cover portion 305, shown in FIG. 3c, which can be attached to and placed in electrical contact with the uneven external portion 320′. A top surface of the cover part 350 is then configured to act as a terminal in a secondary cell.

The particulars of the riveting process are not discussed at length but a number of techniques for riveting rivets 305, such as those described herein, are well understood by those skilled in the art.

FIG. 4 schematically shows a cross-sectional view of a cylindrical secondary cell 4000 comprising a rivet 405 extending through an opening 4340 in the casing 434 to which rivet 405 a cover part 410 is attached, thereby forming a terminal rivet assembly 400 corresponding to the example terminal rivet assembly 100 shown and discussed in relation to FIGS. 1A-C. All particulars of the terminal rivet assembly 400 are thus not discussed again in relation to FIG. 4, but it shall be noted that the digits in the tens and unit positions in the reference numerals are corresponding to the digits of the tens and digit positions used in FIG. 1. (I.e. reference numeral 405 denotes the same feature as reference numeral 105 in FIG. 1.)

The cylindrical secondary cell 4000 (also referred to as simply the ‘cell 6000’) comprises an electrode roll 432 housed in a cylindrical casing 434. The electrode roll 432 may be formed of an anode sheet, a cathode sheet, and a separator sheet arranged therebetween to thereby enable a storage of electrical energy. Cathode tabs 432a may extend from a first end of the electrode roll 432 and anode tabs (not shown) may extend from the other end, or vice versa. The cathode tabs 432a and anode tabs may provide connective surfaces to which current collecting plate(s) 436 can be connected, as well as to which the current collecting portion 410b of the terminal rivet 405 can be connected.

The cylindrical casing 434 extends along an axis A between a first end 434t, which may be referred to as a ‘top end 434t’, and a bottom end (not shown) which may be an open end of the casing 434 closed by a lid. The closure of the casing may comprise a clamped closure or a welded closure, depending on the implementation.

For example, the casing 434 may further comprise a beading groove (not shown) formed in the side wall 434s. Hence, between the beading groove and the end edge of the side wall towards the bottom end of the casing, a clamping portion can be formed. A lid gasket may then be clamped around the bottom lid in the clamping portion to thereby seal the open bottom end of the casing. Providing a clamped closure in this way is well known in the art and thus can provide a reliable waterproof seal for the cell.

As another example, the lid may be welded to the casing to thereby seal the casing. The lid may be additionally welded to a current collector, or the lid may act as a current collector itself and be attached (e.g., welded) to the tabs of the electrode assembly 432. Providing a welded closure in this way may advantageously remove the number of components of the cell and/or the number of process steps required to manufacture the cell.

A cathode current collecting plate 436 is arranged in direct electrical contact with the cathode tabs 432a and an anode current collecting plate (not shown) may be arranged in direct electrical contact with the anode tabs (also not shown). Here, the labels ‘cathode’ and ‘anode’ may be swapped. Thus, an electrical connection is formed from the cathode tabs 432a to the terminal assembly, as the terminal assembly is connected to the current collecting plate 436.

An electrical connection may also formed from the anode tabs to the casing 434, either directly or through connection of an anode current collecting plate to the casing 434, e.g. in the clamping portion or by welding. One or both or the current collectors may be formed as a disc, a plate, or have some other shape.

At either end of the cell, the cell may further comprise a vent for venting gases, for example during a failure of the cell. Moreover, the cell may comprise an additional through-hole, in the casing and/or the lid, for filling the cell with a liquid electrolyte. This through-hole is preferably adapted to be closed from the outside, such as through the use of a blind rivet.

The rivet 405 of the terminal rivet assembly 400 comprises a current collecting portion 410b joined to a shaft 410a of the shaft of the rivet 405. The current collecting portion 410b is intended to act as a current collecting plate in the cylindrical secondary cell 4000. In the secondary cylindrical cell 4000, the current collection portion 410b is provided as a cathode current collecting plate arranged in direct electrical contact with the cathode tabs 432a. Here, the labels ‘cathode’ and ‘anode’ may be swapped. Thus, an electrical connection is formed from the cathode tabs 432a to the rivet 400 and from the rivet 400 and to the cover part 450, as the current collecting portion 410b is an integral part of the rivet 405 and the cover part 650 is attached to the external portion 420 of the rivet 400.

Thus, it is seen that the exposed outer top surface of the cover part 450 serves as an external terminal of the cell 4000, this being a positive terminal in this example, and the casing 434 serves as the negative terminal. Hence, it is seen that both terminals of the cell 6000 are accessible at the same side. The top end 434t of the casing 434 comprises a first electrical contact surface extending in a first plane, and the outer top surface of the cover part 450 comprises a second electrical contact surface, extending in a second plane axially spaced from the first plane.

As discussed above, the cover part 450 provides a flat surface for an external terminal of the cell 4000, irrespective of the shape of the surface of the external portion 420 of the rivet 405. During riveting, the external portion 420 of the rivet 400 is deformed which may cause a top surface of the head of the rivet 400 to be substantially uneven.

Arranged around the rivet 400 is a gasket 442 configured to form a fluid-tight seal for the opening 4340 in the top end 434t of the casing 434. The gasket 442 is arranged at least around the shaft of the rivet 400. The gasket 442 further extends between the external portion 420 of the rivet 405 and the top end 434t of the casing 434 so as to electrically isolate the opposite terminals of the cell 4000 from each other. Thus, it can be seen that gasket 442 serves multiple purposes. The gasket 442 may be preferably formed of a polymer having elastic, resilient, and electrically insulating properties, such as PFA. In preferred examples, including that illustrated in FIG. 4, the gasket 442 extends between the external portion of the rivet 405 and the casing 434, radially beyond the head of the rivet 400.

In some examples, the gasket 442 may be formed of separate parts, each part being specifically configured for a respective purpose. For example, for the part(s) of the gasket 442 around the opening 4340 and intended to seal the opening, the gasket 442 may be formed of one material such as PFA. For the part(s) of the gasket 442 between the head of the rivet 400 and the casing 434 and intended to electrically isolate these components from each other, the gasket 442 may be formed from another material such as a PPS polymer.

The electrode roll 432 is arranged around a center pin 446, although in other examples, this may be an empty space or cavity.

FIG. 5 schematically shows a cross-sectional view of a cylindrical secondary cell 5000 comprising a rivet 505 extending through an opening 5340 in the casing 534 to which rivet 505 a cover part 550 is attached, thereby forming a terminal rivet assembly 500 corresponding to the example terminal rivet assembly 200 shown and discussed in relation to FIGS. 2A-C. All particulars of the terminal rivet assembly 500 are thus not discussed again in relation to FIG. 5. Aside from this difference, the cylindrical secondary cell 5000 corresponds to the cylindrical secondary cell 4000 shown and discussed in relation to FIG. 4. All particulars of the cylindrical secondary cell 5000 are thus not discussed again in relation to FIG. 5.

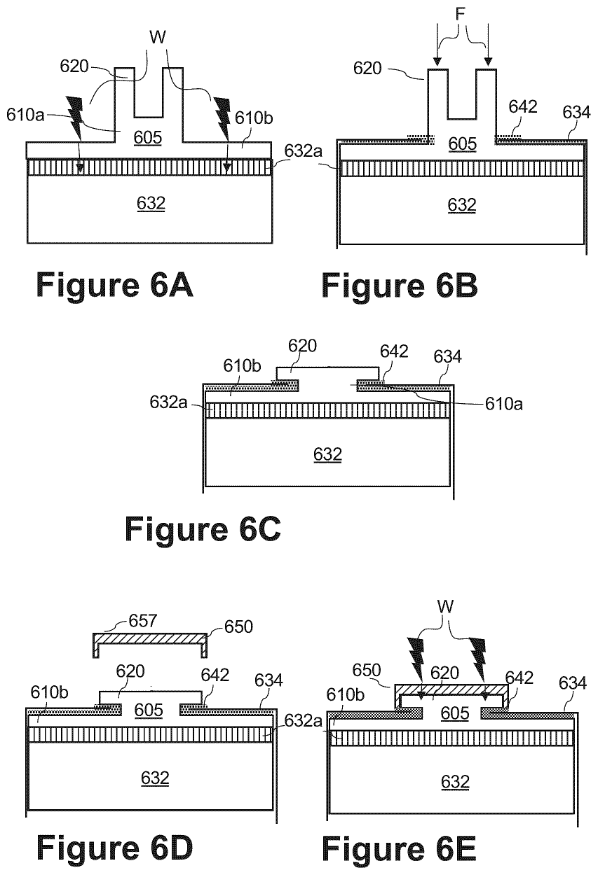

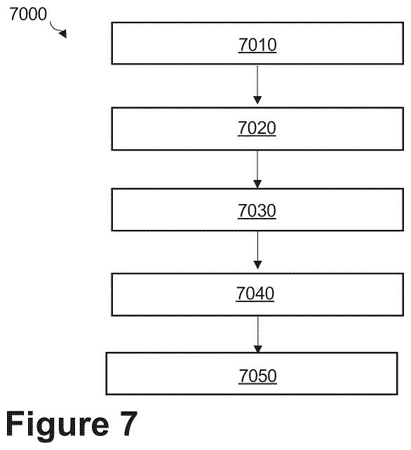

FIGS. 6A-6E show an arrangement and welding of a rivet 605 and to electrode tabs 632a of an electrode roll 632, according to aspects of the present disclosure, as well as arrangements for riveting the rivet 605 to deform the external portion 620, and also arrangements for welding the cover part 650 to the external part 620. FIG. 7 illustrates a method of manufacturing a (part of) cylindrical cell according to aspects of the present disclosure, which method includes the manufacturing steps illustrated in FIGS. 6A-B, which method also optionally includes the manufacturing steps illustrated in FIGS. 6C-6E.

FIG. 6A specifically illustrates the step of directing 7010 a welding means to the current collecting portion to thereby weld the current collecting portion to a connecting portion of the electrode roll, to provide an electrical connection between the external portion and the electrode roll, which is performed before the electrode roll 632 and the terminal rivet 605 is inserted into a casing of the cylindrical cell. In the illustrated example, arrows are drawn to illustrate the path through the material of the rivet 605 along which the welding energy from the welding means W travels.

FIG. 6B specifically illustrates the step of arranging 7020 the rivet 605and the electrode roll 632 in the cylindrical casing 634 such the rivet is arranged at a first end of the cylindrical casing 634, and riveting 7030 the rivet 605, to deform the external portion 620 and thereby attach the rivet 605 to the cylindrical casing 634.

The riveting 7030 is performed by means known to a person skilled in the art, but involves applying forces sufficient to plastically deform the external portion 620 of the rivet 605. The dimensions of the shaft 610 of the rivet external portion 610 are selected such that, after riveting, the size and shape of the external portion 610 can cover and seal the opening in the casing 632. Before riveting, a gasket 642 is preferably provided between the external portion 620 and the casing 634.

FIG. 6C shows and example of the terminal cell after the riveting step 7030. If the external portion 620 is sufficiently flat, the secondary cell would be ready to use in its applications. Alternatively, there may be provided additional step of machining the external portion to provide a flat surface. Or, as it disclosed in more detail below, the method 7000 may further comprise step(s) relating to the attachment of a cover part 650 on the external portion 620.

FIG. 6D specifically illustrates the optional step of arranging 7040 the cover part 650 to cover and with an inner surface electrically contact the external portion 620 of the rivet 805. Hence, there is provided a flat surface 657 which can act as a terminal in the secondary cell.

As is shown in FIG. 6E, the method further optionally comprises directing 7050 a welding means W to the outer surface of the cover part, to thereby weld the cover part 650 to the external portion 620 of the rivet 605. The welding means W may be the same or different to that used to weld the current collecting portion 610b of the rivet 605 to the electrode tabs 632a of the electrode roll 632. In the illustrated example, arrows are drawn to illustrate the path through the material of the cover part 650 along which the welding energy from the welding means W travels.

The welding means W is advantageously applied from an outside of the casing during assembly of the cell, thereby simplifying the manufacture thereof. The remaining steps for manufacturing the cell are not discussed in detail herein, but are well understood by those skilled in the art.

While the present disclosure is susceptible to various modifications and alternative forms, specific embodiments are shown and described above by way of example in relation to the drawings, with a view to clearly explaining the various advantageous aspects of the present disclosure. It should be understood, however, that the detailed description herein and the drawings attached hereto are not intended to limit the disclosure to the particular form disclosed. Rather, the intention is to cover all modifications, equivalents, and alternatives falling within the scope of the following claims.

1-18. (canceled)

19. A terminal assembly (100) for a cylindrical secondary cell comprising:
a rivet (105) comprising:
an external portion (120) configured to close an opening in a casing of the cylindrical cell, to be arranged on the outside of the casing, and to deform during riveting such that an outer facing surface of the external portion (120) becomes substantially uneven, and
an internal portion (110) configured to provide a direct electrical connection between an electrode roll in the secondary cell and the external portion (120), the internal portion (110) comprising:
a shaft (110a) configured to extend axially through the casing of the secondary cell from the external portion (120), and
a current collecting portion (110b) joined to the shaft (110a) at a first end of the shaft (110a), configured to be in direct electrical contact with the electrode roll in the secondary cell, to thereby function as a current collecting plate in the secondary cell,
wherein:
the external portion (120) of the rivet extends like a flange from the second end of the shaft (110a), and
the terminal assembly (100) further comprises a cover part (150) configured to be attached to the rivet (105) to cover and with an inner surface (155) electrically contact the external portion (120) of the rivet, such that an outer surface (157) of the cover part (150) is configured to form a terminal surface of the secondary cell.

20. The terminal assembly (100) according to claim 19, wherein the shaft (110a) of the rivet (105a) is cylindrical and configured to extend axially through a circular opening in the casing of the cylindrical secondary cell.

21. The terminal assembly (100) according to claim 20, wherein the current collecting portion (110b) is substantially disc-shaped.

22. The terminal assembly (100) according to claim 21, wherein the external portion (120) of the rivet is substantially disc-shaped.

23. The terminal assembly (100) according to claim 22, wherein a diameter of the current collecting portion (110b) is larger than a diameter of the external portion (120), and wherein a diameter of the external portion (120) is larger than a diameter of the shaft (110a).

24. The terminal assembly (100) according to claim 19, wherein the cover part (150) comprises:
a substantially disk-shaped portion (150a), wherein a first surface (157) of the substantially disk shaped portion forms the outer surface of the cover part being configured to form a terminal surface of the secondary cell; and
a wall portion (150b) extending from the periphery of the substantially disc shaped portion on a second surface (155) of the disc-shaped portion (150a).

25. The terminal assembly (100) according to claim 24, wherein a height of the wall portion (150b) of the cover part substantially corresponds to a thickness of the external portion (120) of the rivet (100).

26. The terminal assembly (100) according to claim 25, wherein diameter of the substantially disc-shaped cover part (155a) substantially corresponds to a diameter of the external portion (120) of the rivet.

27. The terminal assembly (100) according to claim 24, wherein diameter of the substantially disc-shaped cover part (155a) substantially corresponds to a diameter of the external portion (120) of the rivet.

28. The terminal assembly (100) according to claim 19, wherein the cover part (150) is configured to completely cover the external portion (120) of the rivet (105), when the rivet (105) is arranged in the secondary cell.

29. The terminal assembly (100) according to claim 19, wherein the outer surface (157) of the cover part (150) is substantially flat.

30. The terminal assembly (100) according to claim 19, wherein the current collecting portion (110b) comprises a first side (126) to which the shaft is joined, and a second side (128) configured to contact the electrode roll.

31. The terminal assembly (100) according to claim 19, wherein the external portion (120) of the rivet comprises a first side (121) to which the cover is configured to be attached, and a second side (124) to which the shaft (110a) is joined.

32. A cylindrical secondary cell (4000), comprising:
an electrode roll (432) housed in a cylindrical casing (434); and
the terminal assembly (400) according to claim 19, arranged at a first end of the cylindrical casing,
wherein an outer surface of the cover part (450) forms a terminal surface of the cylindrical secondary cell.

33. A method (7000) of manufacturing the cylindrical cell according to claim 32, the method comprising:
directing (7010) a welding means to the current collecting portion to thereby weld the current collecting portion to a connecting portion of the electrode roll, to provide an electrical connection between the external portion and the electrode roll,
arranging (7020) the rivet and the electrode roll in the cylindrical casing such the rivet is arranged at a first end of the cylindrical casing,
riveting (7030) the rivet, to deform the external portion and thereby attach the rivet to the cylindrical casing,
arranging (7040) the cover part to cover and with an inner surface electrically contact the external portion of the rivet, and
directing (7050) a welding means the outer surface of the cover part, to thereby weld the cover part to the external portion of the rivet.
